(19) United States
(12) Patent Application Publication
(10) Pub. No.: US 2011/0091168 A1
(43) Pub. Date: Apr. 21, 2011

(54) OPTO-ELECTRICAL ASSEMBLIES AND ASSOCIATED APPARATUS AND METHODS

(75) Inventors: Odd Robert Steijer, Bromma (SE); Hans Magnus Emil Andersson, Jarfalla (SE); Maria Elisabeth Kãllén, Stockholm (SE)

(73) Assignee: ZARLINK SEMICONDUCTOR AB, Jarfalla (SE)

(21) Appl. No.: 12/581,364

(22) Filed: Oct. 19, 2009

(51) Int. Cl. G02B 6/36

(52) U.S. Cl. 385/88

(57) ABSTRACT

There is provided an opto-electrical assembly. The assembly comprises an optical carrier and one or more optical elements and possibly also electrical elements, such as optical flip-chip die, attached to the optical carrier, and configured for electrical and optical communication with the optical carrier. The assembly further comprises a flexible electrical and optical connectors attached to the optical carrier, and configured to provide electrical and optical communication between the one or more optical and electrical elements and further circuitry. Wherein the flexible connectors are configured to allow for relative movement of the optical carrier and further circuitry during use of the assembly.

### FIELD OF THE INVENTION

The present invention relates to the field of opto-electrical assemblies, and associated apparatus and methods.

### BACKGROUND OF THE INVENTION

Opto-electrical assemblies typically comprise a plurality of components, which may be purely optical, purely electrical, a combination of optical and electrical, or merely structural/thermal. Generally, these components are in thermal and mechanical communication with one another, but can also be in optical and/or electrical communication too. Consequently, the manner in which one component operates may affect the characteristics of further components.

Unwanted influence between components can have an adverse effect on the operation of the assembly. For example, consider the transfer of heat from one component to a further component. In such instances, the properties of the latter component may change adversely. Also, the thermal deposition in that latter component may result in mechanical changes in size, which may affect characteristics such as optical alignment, or may induce stresses that affect mechanical reliability etc.

Therefore, it can be considered valuable to isolate each component as much as possible. However, this is in contrast with the desire to tightly integrate components within assemblies, which has the effect of exacerbating problems associated with unwanted influence. Consideration is needed as to how to provide opto-electrical assemblies, which are easy to manufacture, satisfy the space requirements, and mitigate unwanted optical, electrical, mechanical and thermal influence. There is value providing components as close together as possible when communicating at high speeds (e.g. in excess of 10 GHz).

FIG. 1a shows an embodiment of an opto-electrical assembly as known in the art. FIG. 1b illustrates the connection between the optical element and integrated circuit of the opto-electrical assembly of FIG. 1a. FIG. 1c illustrates the heat dissipation of the opto-electrical assembly of FIG. 1a.

FIG. 1a shows an opto-electrical assembly 100, comprising a lens 110, optical element 120, printed circuit board 140, heat sink 150 and electrical element, which in this case is an integrated circuit 130.

The optical element 120 and integrated circuit 130 are attached mechanically and electrically to the printed circuit board 140, which allows for electrical signals to be passed between both the optical element 120 and integrated circuit 130. In this example, the optical element 120 and integrated circuit 130 are electrically connected using wire bonds 160. This is shown diagrammatically in FIG. 1b.

The printed circuit board 140 is also in mechanical communication with the heat sink 150. In use, heat generated by the optical element 120 and integrated circuit 130 is communicated through the printed circuit board 140 to the heat sink 150. This is shown in FIG. 1c.

As is shown in FIG. 1a, the heat sink 150 in this example is also in mechanical communication with the lens 110. The lens 110 is aligned passively with the optical element 120 by using the structure of the heat sink 150.

When the assembly 100 of FIG. 1a is used, heat is generated by the optical element 120, integrated circuit 130. This heat is deposited, at least in part, in the printed circuit board 103 (i.e. heat is transferred from the integrated circuit 130 through the printed circuit board 140 to the heat sink 150). The thermal conduction properties of the printed circuit boards 140 are such that the heat is not as efficiently dissipated compared to an example when the optical element 120 and integrated circuit 130 are in communication with the heat sink 150 directly.

Unwanted movement and stress in the assembly 100 also occurs, due at least in part to mismatch between properties of the different component (e.g. differences in the coefficient of thermal expansion, etc.). As a result, the alignment of the optical element 120 can be affected. Similarly, because of unwanted movement/stresses, the alignment of the lens 120 can be affected. For example, referring to FIG. 1d, a region 170 of the heat sink 150 that is in mechanical communication with the lens 110 may move or warp, causing the lens 110 to move or change alignment.

### SUMMARY OF THE INVENTION

Broadly, disclosed is a opto-electrical assembly that balances optical, electrical, thermal and mechanical connections for non-hermetic, low cost equipment practice for high speed optical engines for easy integration into optical modules.

According to a first aspect of the invention there is provided an opto-electrical assembly, the assembly comprising an optical carrier; one or more optical elements attached to the optical carrier, and configured for electrical communication with the optical carrier; a flexible connector attached to the optical carrier, and configured to provide electrical communication between the one or more optical elements and further circuitry, the flexible connector configured to allow for relative movement of the optical carrier and further circuitry during use of the assembly.

Such an assembly may allow for movement, such as movement due to thermal expansion, during use to be accommodated or tolerated. Such an assembly may allow for regions or portions of the assembly to be fixed to a module of device (e.g. a heat dissipater to a casing, or the like), without unwanted stresses being induced in the assembly.

The flexible connector may comprise a foil or sheet. The flexible connector may comprise a first portion and a second portion, wherein the first portion is movable with respect to the second portion. The first portion may be rotatable with respect to the second portion. The first portion may be translatable with respect to the second portion. The first portion may be attached to the carrier, while the second portion may be configured for attachment to, or communication with, further circuitry.

The assembly may further comprise an optical guide. The optical guide may be attached to the optical carrier. The optical guide may be fixedly or moveably attached to the carrier. The optical guide may comprise a fibre guiding portion. The optical guide may comprise a lens portion. The optical guide may comprise an optical fibre so as to provide for optical communication to/from the one or more optical elements. The optical fibre may be a flexible fibre. The flexible fibre may allow for movement, such as movement due to thermal expansion, of the assembly during use to be accommodated.

The optical carrier may be a fully or partially transparent carrier. The optical carrier may be a glass carrier. The optical carrier may be a silicon carrier. The one or more optical elements may be attached to the optical carrier such that they receive and/or transmit optical signals through the optical carrier. The assembly may be configured such that the optical guide guides an optical signal to/from the one or more optical elements through the optical carrier. The optical carrier may be provided with one or more electrical communication paths for communicating electrical signals to/from the one or more optical elements and the flexible connector. The communication paths may be provided by a metalized pattern.

The assembly may be configured such that the coefficient of thermal expansion of the optical carrier and the one or more optical elements is roughly the same, or similar.

The assembly may comprise a heat dissipater. The heat dissipater may be in thermal communication with the one or more optical elements and/or one or more electrical elements (such as an IC). The heat dissipater may be in thermal connection with the one or more optical elements and the one or more electrical elements (such as an IC) via an adhesive. The one or more optical elements and electrical elements (such as an IC) may be fully or partially covered by a sealant, or the like. The heat dissipater may be in thermal communication with the one or more optical elements and electrical elements (such as an IC) via the sealant. The heat dissipater may be in thermal communication with the optical carrier.

The heat dissipater may be configured for attachment to a heat sink, such as casing of a device or module, or the like. The assembly may be configured such that the heat dissipater is provided on an opposite side of the optical carrier to the optical guide.

The one or more optical elements may be optical receivers, such as 4-channel optical receivers. The one or more optical elements may be optical transmitters, such as 4-channel optical transmitters. The assembly may be configured as a multi-channel array. The one or more optical elements may be optical die.

The assembly may comprise one or more electrical elements, such as integrated circuits (e.g. application specific integrated circuits, field programmable gate arrays, microcontrollers, programmable intelligent computers, or the like). The one or more electrical elements may be for use with the one or more optical elements. The one or more electrical elements may be attached to the optical carrier. The one or more electrical elements may be in electrical communication with the one or more optical elements via the optical carrier (e.g. using the metalized pattern). The one or more electrical elements may be attached to the same side of the carrier as the one or more optical elements.

The one or more optical/electrical elements may be attached to the optical carrier using solder, such as solder bumps. The one or more optical/electrical elements may be flip chip elements.

The flexible connector may comprise an aperture. The assembly may be configured such that the optical carrier is received at least partially within the aperture. The optical carrier may be attached to a periphery region of the aperture. The flexible connector may be attached to a periphery region of the optical carrier.

The optical carrier may be soldered, glued, or the like, to the flexible connector. The aperture may be configured to allow for the one or more optical/electrical elements to be in thermal communication with the heat dissipater.

The assembly may comprise a substrate. The substrate may be in communication with the one or more optical elements via the flexible connector. The substrate may be provided by a printed circuit board, or the like. The substrate may comprise surface mounted technology. The substrate may be configured to allow for communication with the further circuitry, and further apparatus, modules, devices, etc. For example, the substrate may comprise a module connector, slot connector, or the like.

According to a second aspect of the invention there is provided an opto-electrical assembly, the assembly comprising one or more optical elements and one or more electrical elements attached to an optical carrier; a heat dissipater, in thermal communication with the one or more optical elements and one or more electrical elements, and configured for thermal communication with casing of an optical module or device; an optical guide, the optical guide comprising a flexible fibre in optical communication with the one or more optical elements through the carrier; and a flexible connector, the flexible connector attached to the optical carrier to provide electrical communication between the optical carrier and further circuitry; and wherein the optical guide and flexible connector are configured to allow for movement of the assembly in use.

According to a third aspect of the invention there is provided an opto-electrical assembly, the assembly comprising one or more optical elements and one or more electrical elements attached to an optical carrier; a heat dissipater, in thermal communication with the one or more optical elements and one or more electrical elements, and configured for thermal communication with casing of an optical module or device; an optical guide, the optical guide comprising a flexible fibre in optical communication with the one or more optical elements through the carrier; and a flexible connector, the flexible connector attached to the optical carrier to provide electrical communication between the optical carrier and further circuitry; and wherein the optical guide and flexible connector are configured to allow for movement of the carrier and further circuitry during use of the assembly.

According to a fourth aspect of the invention there is provided an opto-electrical assembly, the assembly comprising one or more optical elements attached to an optical carrier; a flexible connector attached to the optical carrier, and configured to provide electrical communication between the one or more optical elements and further circuitry, the flexible foil connector configured to allow for movement the assembly during use, such as relative movement of the assembly and further circuitry.

According to a fifth aspect of the invention there is provided an optical module or device, the optical module or device comprising an assembly according to any of the features of the first, second, third or fourth aspects.

The optical module or device may comprise a casing. The module or device may be configured such that a heat dissipater is in thermal communication with the casing. The heat dissipater may be in fixed or movable communication with the casing.

According to a sixth aspect of the invention there is provided a means for an opto-electrical circuit assembly, the means for an opto-electrical circuit assembly comprising one or more means for optical signalling attached to a means for carrying; a flexible means for connection, the flexible means attached to the means for carrying, and configured to provide electrical communication between the one or more means for optical signalling and further circuitry, the flexible means for connection configured to allow for relative movement of the means for carrying and further circuitry during use of the means for an opto-electrical circuit assembly.

According to a seventh aspect of the invention there is provided apparatus comprising one or more optical and electrical flip chip die soldered to a metalized pattern of a glass support; a heat stud, in thermal communication with the one or more optical and electrical die, and configured for thermal connection with casing of an optical module or device; an optical guide, the optical guide configured to receive an optical fibre to allow communication of optical signals with the one or more optical die through the glass support; a flexible circuit, the flexible circuit attached to the glass support to provide electrical communication between the one or more optical die and further circuitry; and wherein the flexible circuit has a glass carrier attachment portion and a module attachment portion, the glass carrier attachment portion being movable with respect to the module attachment portion to allow for movement of the apparatus in use.

According to an eighth aspect of the invention there is a method of providing an opto-electrical assembly. The method may include providing any of the features of any of the above aspects. The method may include providing one, some or all of the features in a non-hermetic environment.

Other aspects and advantages of embodiments of the invention will be readily apparent to those ordinarily skilled in the art upon a review of the following description.

### BRIEF DESCRIPTION OF THE DRAWINGS

Embodiments of the invention will now be described in conjunction with the accompanying drawings, wherein:

FIG. 1a shows an embodiment of an opto-electrical assembly as known in the art;

FIG. 1b illustrates the connection between the optical element and integrated circuit of the opto-electrical assembly of FIG. 1a;

FIG. 1c illustrates the heat dissipation of the opto-electrical assembly of FIG. 1a;

FIG. 1d; shows an alternative design of an opto-electrical assembly containing a passively aligned lens (including light path) and a heat sink.

FIG. 2a shows an embodiment of an opto-electrical assembly in accordance with the teachings of this invention;

FIG. 2b is a side view of the opto-electrical assembly of FIG. 2a taken along section A-A;

FIG. 2c shows a flexible connector that can be used with the opto-electrical assembly of FIG. 2a in accordance with the teachings of this invention;

FIG. 2d illustrates another embodiment of the opto-electrical assembly of FIG. 2a, a side view of FIG. 2c but with a 90 deg bend of the flex foil;

FIGS. 3a, 3b, and 3c show the opto-electrical assembly of FIG. 2a comprising a printed circuit board, wherein FIG. 3a is a top view, FIG. 3b is a side view, and FIG. 3c is a perspective view;

FIG. 4 shows the opto-electrical assembly of FIG. 2a comprising a heat dissipater;

FIG. 5a shows an embodiment of an opto-electrical assembly comprising a mechanical interface for an optical single fiber connector in accordance with the teachings of this invention;

FIG. 5b illustrates the opto-electrical assembly of FIG. 5a with a heat sink and PCB including electrical circuitry;

FIG. 5c illustrates the opto-electrical assembly of FIG. 3 with a multifiber optical attachment;

FIGS. 6a, 6b, and 6c show further examples of assemblies comprising optical guides in accordance with the teachings of this invention; and

FIGS. 7a, 7b 8, 9a, 9b and 9c illustrate practical applications of opto-electrical assemblies in accordance with the teachings of this invention.

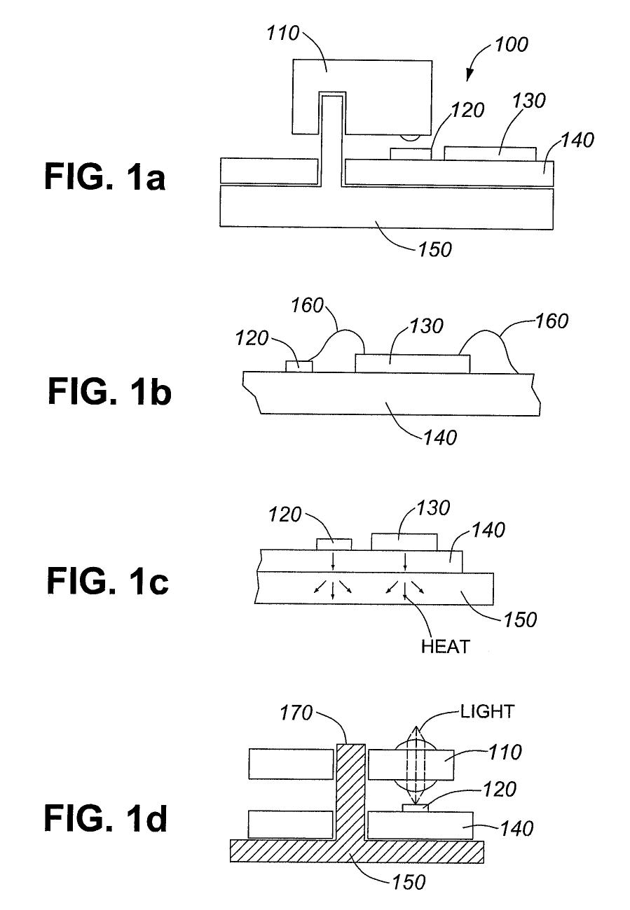

This invention will now be described in detail with respect to certain specific representative embodiments thereof, the materials, apparatus and process steps being understood as examples that are intended to be illustrative only. In particular, the invention is not intended to be limited to the methods, materials, conditions, process parameters, apparatus and the like specifically recited herein.

### DETAILED DESCRIPTION OF THE DISCLOSED EMBODIMENTS

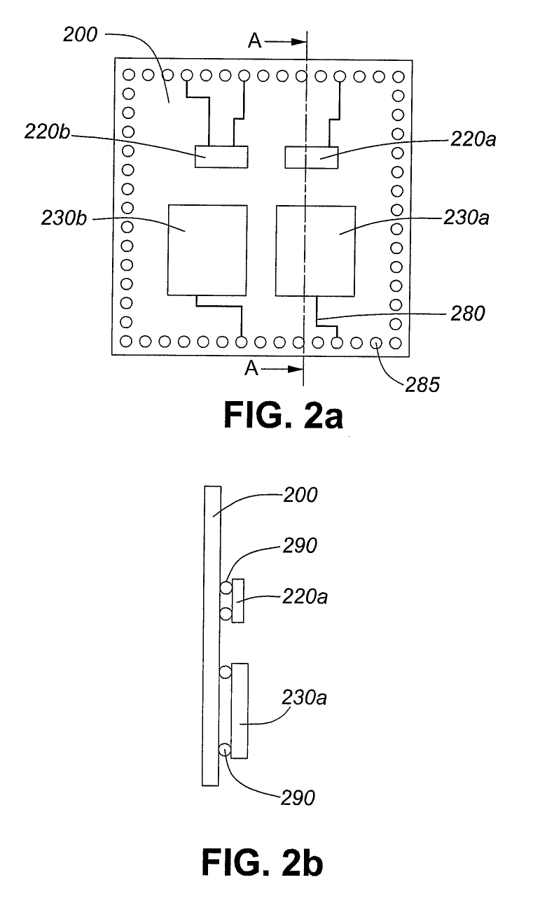

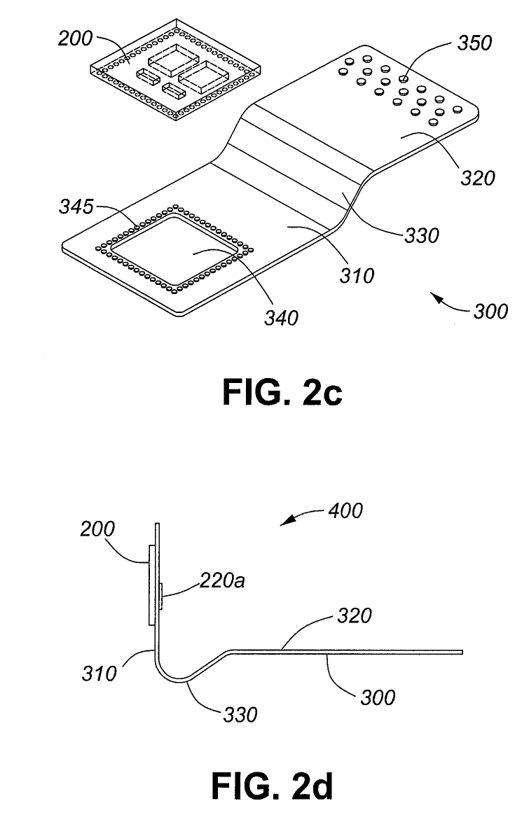

FIG. 2a shows a plan view of an embodiment of an optical carrier 200. In this example, the optical carrier 200 has two attached optical elements 220a, 220b and two attached electrical elements, which in this case are integrated circuits 230a, 230b for use with the optical elements 220a, 220b. The optical carrier 200 comprises glass, such as Pyrex™, or the like. The carrier 200 is transparent. However, the carrier has a metalized pattern 280 to provide electrical communication between the optical element 220a, 220b and the integrated circuit 230a, 230b, as well as to a perimeter region 285 of the carrier 200, which allows for electrical connection with a flexible connector 300, as will be described. Because the carrier 200 is glass, the co-efficient of thermal expansion of the carrier 200 and the optical element 220a, 220b should preferably be matched.

Here, the optical elements 220a, 220b are provided by optical die. One optical element is a 4-channel receiver, while the other optical element is a 4-channel transmitter. In this example, they are configured as a multichannel array. It will be appreciated that this configuration is exemplary only. The carrier may have any number of optical elements. The carrier may have any number of electrical elements.

FIG. 2b shows a side view of the carrier 200 at section A-A of FIG. 2a, in which one of the optical elements 220a and one of the integrated circuits 230a are visible. In this instance, both the optical element 220a and the integrated circuit 230a are flip chips. Both flip chips are soldered to corresponding region of metalized pattern 280 on the carrier 200, which in this instance is by using solder bumps 290. The carrier 200 and optical element 220a are configured such that optical signals are communicated through the carrier 200 in order to be communicated to/from the optical element 220a.

FIG. 2c shows a flexible connector 300 for use with the carrier 200. The connector is provided by a flexible foil, or sheet. The connector 300 comprises a first portion 310 and a second portion 320. The first portion 310 is moveably connected to the second portion 320 at a joined region 330. Here, the first portion 310 can rotate with respect to the second portion 320. The first portion 310 can also translate with respect to the second portion 320.

The first portion 310 has an aperture region 340. The carrier 200 and connector 300 are configured such that they make electrical and mechanical connection at a perimeter region 345 of the aperture region 340. The second portion 320 comprises a terminal 350 for connecting the connector 300 to a substrate, such as a printed circuit board, or the like. The terminal 350 may be considered to be a connector for connecting to a substrate, but equally the 350 terminal may be configured for connecting to a device or module, etc.

The connector 300 comprises electrical communication paths arranged in a known manner, which pass from the aperture region 340 to the terminal 350 and allow for electrical signals to be communicated from further circuitry to and from the optical carrier 200, and thus the optical element 220a, 220b/integrated circuit 230a, 230b.

An assembly 400, comprising the carrier 200 and connector 300 is shown in FIG. 2d. In FIG. 2d, the first portion 310 of the connector 300 is provided in a plane perpendicular to the plane of the second portion 320. Here, the carrier 200 has been attached to the flexible connector 300 using solder, or glue (e.g. conductive adhesive, or non-conductive adhesive and conductive studs). It can be seen from FIG. 2d that the optical element is received through the aperture 340 of the flexible connector 300.

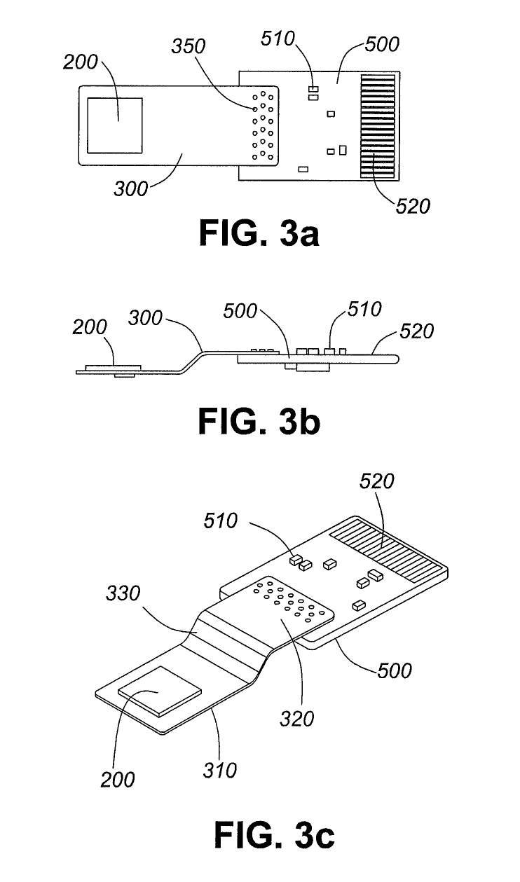

FIG. 3 shows the assembly 400 connected to a substrate 500, which in this instance is a printed circuit board 500. The printed circuit board 500 comprises a plurality of surface mounted technologies 510 for use with the assembly 400. The printed circuit board 500 further comprises a module connector 520, which in this example is a slot connector for connecting electrically the assembly 400 to further modules or devices.

It will be appreciated that in some embodiments, the flexible connector may comprise the module connector 520.

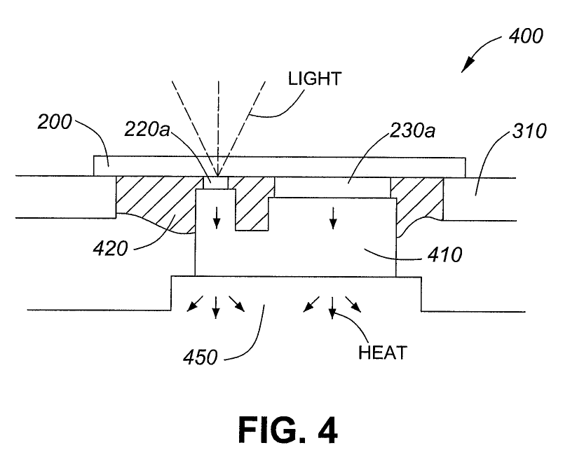

FIG. 4 shows a cross-section of the assembly 400, further comprising a heat dissipater 410. The dissipater 410 is in thermal communication with the optical elements 220a, 220b and, in this instance, the integrated circuits 230a, 230b too. The heat dissipater 410 is configured for attachment to a heat sink 450, such as casing or the like of an optical device or module. Of course, in other examples, the heat dissipater 410 may be provided such that it is not configured for attachment with a heat sink 450 (e.g. may be provided with fins, etc., to allow for heat dissipation of the optical element 220a, 220b/integrated circuit 230a, 230b).

Adhesive 420 has been used to attach the heat dissipater 410 with the assembly 400. The adhesive 420 also serves to protect the optical elements 220a, 220b and integrated circuit 230a, 230b. This means that the optical element 220a, 220b/integrated circuit 230a, 230b can be sealed against contaminants.

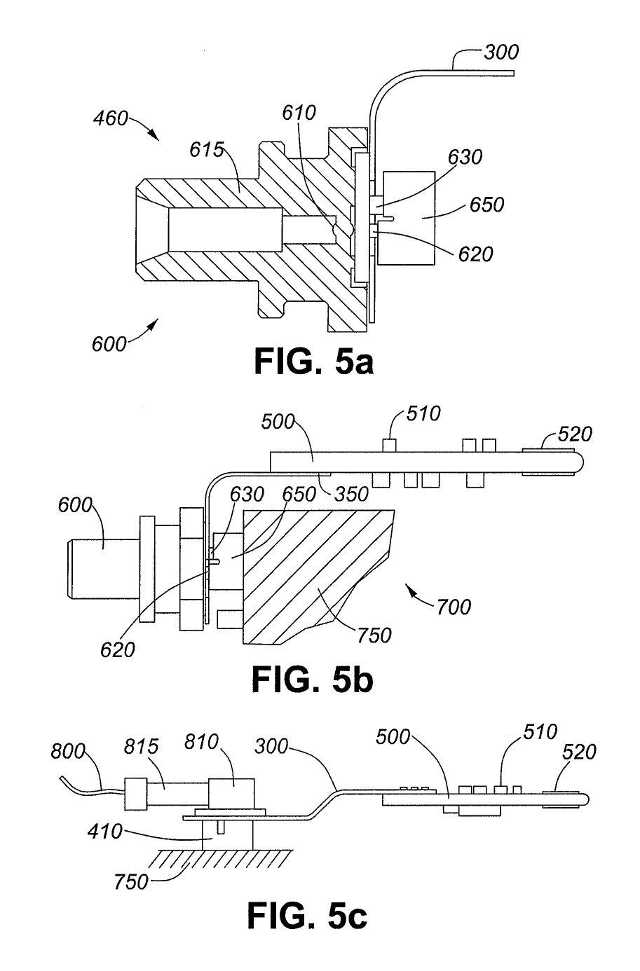

FIG. 5a shows a cross section of an assembly 460 similar to that described above, but comprising a single optical element 620, and in this example, a single integrated circuit 630 for use with the optical element 620.

Here, the assembly 460 comprises an opto-mechanical interface 600 for guiding an optical connector for use with an optical element 620. In this example, the opto-mechanical interface 600 is attached to the carrier 200, and comprises a lens portion 610 and a fibre guiding portion 615. The fibre guiding portion 615 is configured to receive an optical fibre and align the received optical fibre with the lens portion 610 to allow for communication to/from the optical element 620. While in this example, the fibre guiding portion 615 and the lens portion 610 are integral with the opto-mechanical interface 600, that need not always be the case: each may be provided individually.

FIG. 5b shows an embodiment of the assembly 460 shown in FIG. 5a, but provided with an optical module or device 700. Here, the flexible connector 300 is connected to printed circuit board 500, and a heat dissipater 650 is connected to casing 750, or the like, of the device or module 700.

FIG. 5c shows a similar configuration to that described in FIGS. 5a and 5b, but with the assembly 400 of FIG. 4 (i.e. here, the assembly 400 has more than one optical element 220a, 220b). The assembly 400 comprises an optical guide, a flexible fibre 800 attached to a lens portion 810 and ferrule portion 815. In this example, the ferrule portion 815 is provided by an MT ferrule.

As can be seen from FIG. 5, during use, the optical element 620, 220a and integrated circuit 630, 230a are in direction communication with the heat dissipater 650, 410 to allow for heat to be communicated efficiently away. Because no wire bonds have been provided between the optical element 620, 220a, integrated circuit 630, 230a and carrier 200, the assembly 400 can operate at significantly higher speeds than a similar configuration in which wire bonds are provided. The elements are also able to be positioned closer together.

In addition, because the electrical and optical connections are flexible, the heat dissipater 650, 410 can be fixable attached to the casing 750, or heat sink 450, or the like, without causing any additional stresses in the assembly 400, 460.

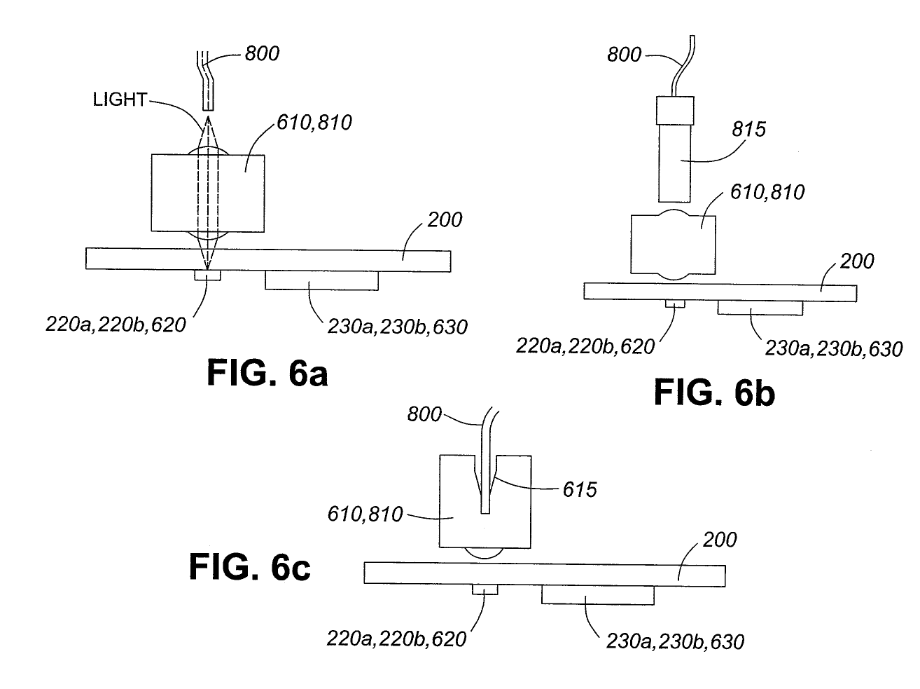

Of course, while in the above examples an opto-mechanical interface 600 having a fibre guide portion 615, ferrule portion 815, or a lens portion 610 have been described, it will be appreciated that any other number of opto-mechanical interface 600 may be used. FIG. 6a shows an example where an optical fibre is positioned with respect to a lens. In FIG. 6b a lens is provided that is distinctly from a ferrule portion, while in FIG. 6c shows an alternative configuration of fibre guide portion and lens portion.

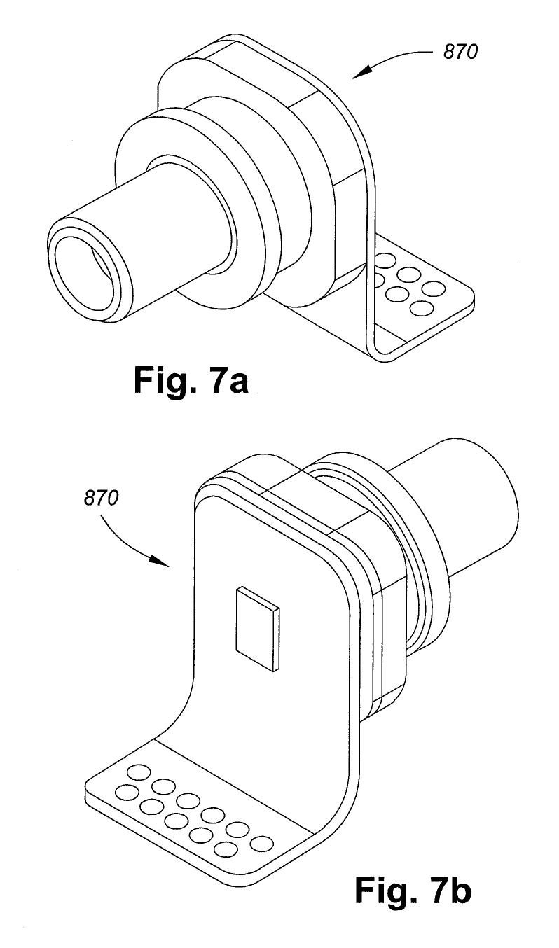

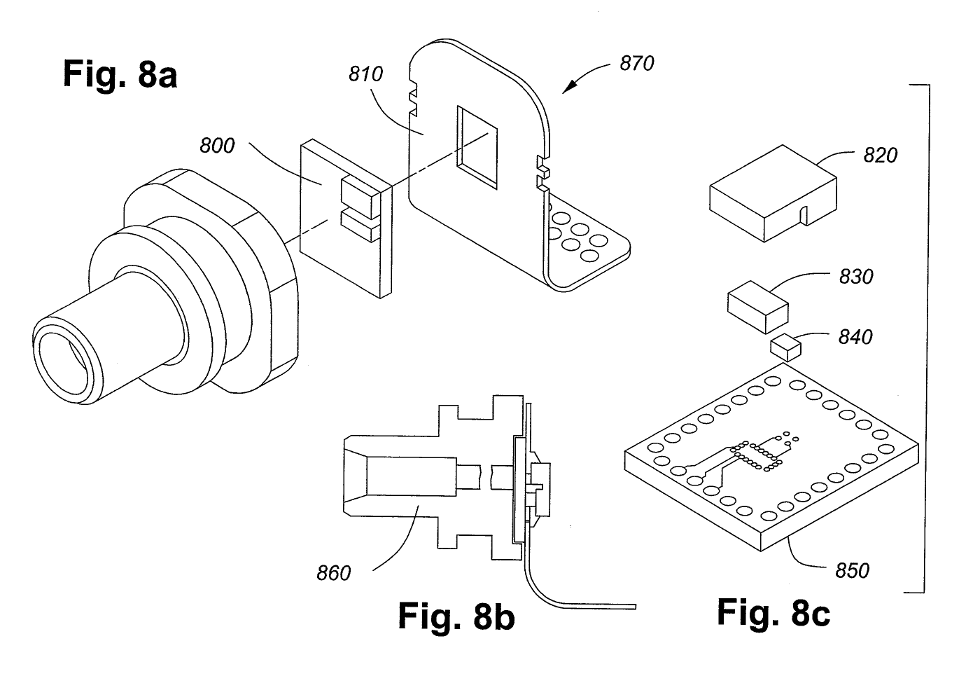

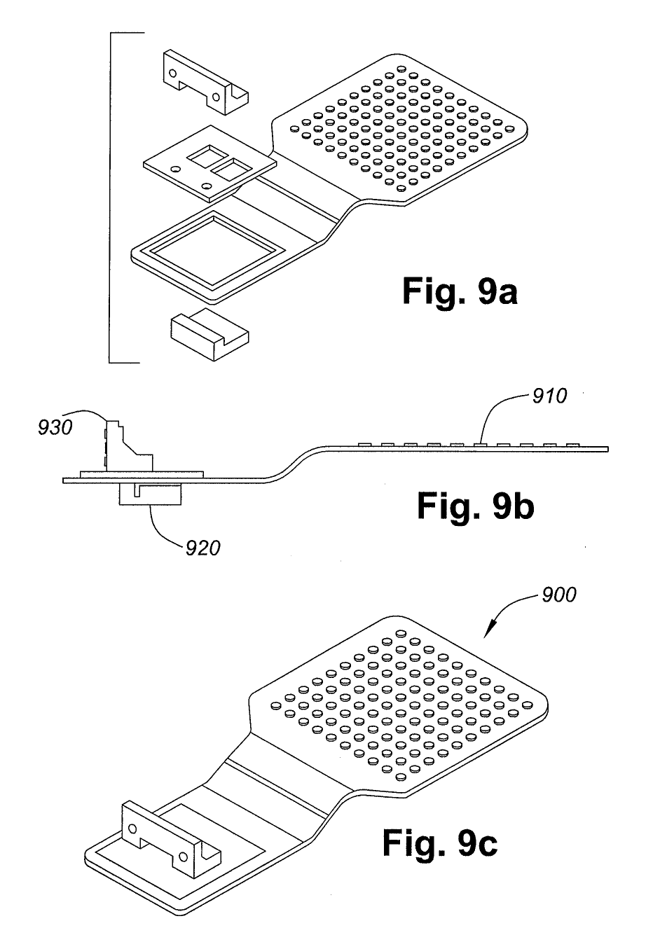

FIGS. 7a, 7b and 8 show a further example of an assembly similar to that described in relation to FIGS. 5a and 5b. FIG. 8 is an exploded view of an optical engine assembly of FIGS. 7a and 7b. In FIG. 8, a optical engine 800 (such as the Zarlink ZOE) is mounted to a flexible PCB 810, along with a ceramic heatsink 820. A VCSEL driver/TIA 830 flip-chip and VCSEL/PIN flip-chip 840 are attached to Pyrex carrier 850. The assembly 870 is enclosed by an LC sleeve (ULTEM Polytherimide, PEI) 860.

FIGS. 9a, 9b and 9c show a further example of the assembly described in relation to FIG. 5c. FIG. 9a is an exploded view and FIG. 9b is a side view of the assembly 900 of FIG. 9c. Illustrated are the electrical 910 interface to the PCB, thermal interface to the heatsink 920 and optical interface 930 to an MT Ferrule.

Although in some of the above examples, two optical elements and two integrated circuits have been described, it will be appreciated that such embodiments are exemplary only. The assembly may comprise one, or more that two optical elements, or one, or more than two integrated circuits. In some example, the assembly comprises only optical elements. For example, the assembly may be provided for a single channel receiver and/or transmitter.

Numerous modifications may be made without departing from the spirit and scope of the invention as defined in the appended claims.

What is claimed is:

1. An opto-electrical assembly comprising:
an optical carrier;
one or more optical and possibly electrical elements attached to the optical carrier, and configured for electrical and optical communication with the optical carrier;
a flexible connector attached to the optical carrier, and configured to provide electrical communication between the one or more optical elements and further circuitry, the flexible connector configured to allow for relative movement of the optical carrier and further circuitry during use of the assembly.

2. The assembly according to claim 1, wherein the flexible connector comprises a foil or sheet.

3. The assembly according to claim 1, wherein the flexible connector comprise a first portion and a second portion, the first portion being movable with respect to the second portion.

4. The assembly according to claim 3, wherein the first portion is rotatable and translatable with respect to the second portion.

5. The assembly according to claim 1, further comprising an optical guide, the optical guide being attached to the optical carrier.

6. The assembly according to claim 5, wherein the optical guide comprises a flexible fibre, the optical guide and flexible fibre configured to allow for movement of the assembly during use.

7. The assembly according to claim 1, wherein the one or more optical elements are attached to the optical carrier such that they receive and/or transmit optical signals through the optical carrier.

8. The assembly according to claim 1, wherein the optical carrier is provided with one or more electrical communication paths for communicating electrical signals to/from the one or more optical elements and the flexible connector, the communication paths being provided by a metalized pattern.

9. The assembly according to claim 1, wherein the coefficient of thermal expansion of the optical carrier and the one or more optical elements is roughly the same.

10. The assembly according to claim 1 further comprising a heat dissipater, the heat dissipater being in thermal communication with the one or more optical and electrical elements via an adhesive

11. The assembly according to claim 10, wherein the adhesive further acts as a sealant, fully or partially covered the one or more optical elements.

12. The assembly according to claim 10, wherein the heat dissipater is configured for attachment to a heat sink, such as casing of a device or module.

13. The assembly according to claim 1, configured as a multi-channel array.

14. The assembly according to claim 1, wherein the one or more optical elements are optical die.

15. The assembly according to claim 1, further comprising one or more electrical elements, such as integrated circuits, the one or more electrical elements for use with the one or more optical elements.

16. The assembly according to claim 1, wherein the one or more optical elements are flip chip elements.

17. The assembly according to claim 1, wherein the flexible connector comprises an aperture region, the assembly configured such that the optical carrier is received at least partially within the aperture region.

18. The assembly according to claim 1, further comprising a substrate, the substrate being in communication with the one or more optical elements via the flexible connector, the substrate being configured to allow for communication with further circuitry.

19. An opto-electrical assembly comprising:
one or more optical and possibly electrical elements attached to an optical carrier;
a heat dissipater, in thermal communication with the one or more optical elements, and configured for thermal communication with casing of an optical module or device;
an optical guide, the optical guide comprising a flexible fibre in optical communication with the one or more optical elements through the carrier; and
a flexible connector, the flexible connector attached to the optical carrier to provide electrical communication between the one or more optical elements and further circuitry; and wherein
the optical guide and flexible connector are configured to allow for movement of the assembly in use.

20. An opto-electrical assembly comprising:
one or more optical and possibly electrical elements attached to an optical carrier;
a flexible connector attached to the optical carrier, and configured to provide electrical communication between the one or more optical elements and further circuitry, the flexible foil connector configured to allow for movement the assembly during use, such as relative movement of the assembly and further circuitry.

21. An optical module or device, the optical module or device comprising an assembly according to claim 20.

22. Apparatus comprising:
one or more optical and possibly electrical flip chip die soldered to a metalized pattern of a glass support;
a heat stud, in thermal communication with the one or more optical die, and configured for thermal communication with casing of an optical module or device;
an optical guide, the optical guide configured to receive an optical fibre to allow communication of optical signals with the one or more optical die through the glass support;
a flexible circuit, the flexible circuit attached to the glass support to provide electrical communication between the one or more optical die and further circuitry; and wherein
the flexible circuit has a glass carrier attachment portion and a module attachment portion, the glass carrier attachment portion being movable with respect to the module attachment portion to allow for movement of the apparatus in use.
